(19) United States
(12) Patent Application Publication
(10) Pub. No.: US 2017/0293377 A1
(43) Pub. Date: Oct. 12, 2017

(54) HANDHELD ELECTRONIC DEVICE

(71) Applicant: Chunghwa Picture Tubes, LTD., Taoyuan City (TW)

(72) Inventors: Chao-Yung Hsu, Taoyuan City (TW); Chih-Chao Chang, Taipei City (TW); Hung-Hsiang Chen, Taoyuan City (TW)

(21) Appl. No.: 15/148,508

(22) Filed: May 6, 2016

(30) Foreign Application Priority Data
Apr. 11, 2016 (CN) 201610222250.9

(51) Int. Cl. G06F 3/044; G06F 3/041

(52) U.S. Cl. CPC G06F 3/044; G06F 3/0412; G06F 2203/04105; G06F 2203/04103

(57) ABSTRACT

The invention provides a handheld electronic device including a case, a touch display module, a pressure sensing layer, and a metal layer. The case has a receiving recess. The touch display module is disposed in the receiving recess and includes an embedded touch display panel and a backlight module located under the embedded touch display panel. The pressure sensing layer is built in the touch display module. The metal layer is disposed in the receiving recess and located under the backlight module. An air gap exists between the metal layer and the backlight module. The pressure sensing layer, the air gap, and the metal layer constitute a capacitor unit. According to the invention, the production costs of the handheld electronic device are reduced and the processes of fabrication are simplified.

### CROSS-REFERENCE TO RELATED APPLICATION

This application claims the priority benefit of China application serial no. 201610222250.9, filed on Apr. 11, 2016. The entirety of the above-mentioned patent application is hereby incorporated by reference herein and made a part of this specification.

### BACKGROUND OF THE INVENTION

### Field of the Invention

The invention relates to an electronic device and particularly relates to a handheld electronic device.

### Description of Related Art

Currently, the integration of a pressure sensing element onto a touch display module is generally achieved by disposing a pressure sensing element layer under a backlight module as an add-on. Since it is an add-on, disposing the pressure sensing element layer will result in increase of the overall thickness of the touch display module. Moreover, because the pressure sensing element layer is disposed on the touch display module as an add-on, an additional circuit board is required for exporting a sensing signal from the pressure sensing element layer. Consequently, the production costs are increased.

### SUMMARY OF THE INVENTION

The invention provides a handheld electronic device, which includes a pressure sensing layer built in a touch display module, for reducing the production costs and simplifying the processes of fabrication.

The handheld electronic device of the invention includes a case, a touch display module, a pressure sensing layer, and a metal layer. The case has a receiving recess. The touch display module is disposed in the receiving recess of the case and includes an embedded touch display panel and a backlight module located under the embedded touch display panel. The pressure sensing layer is built in the touch display module. The metal layer is disposed in the receiving recess of the case and is located under the backlight module. An air gap exists between the metal layer and the backlight module. The pressure sensing layer, the air gap, and the metal layer constitute a capacitor unit.

In an embodiment of the invention, the embedded touch display panel includes a plurality of common electrode patterns that are separated from one another and have touch and pressure sensing functions, wherein the common electrode patterns define the pressure sensing layer.

In an embodiment of the invention, a shape of the common electrode patterns is square or rectangular.

In an embodiment of the invention, the embedded touch display panel is a self-capacitive touch display panel or a mutual-capacitive touch display panel.

In an embodiment of the invention, the pressure sensing layer is built in a peripheral region of an active device array substrate of the embedded touch display panel.

In an embodiment of the invention, the pressure sensing layer includes a plurality of pressure sensing pads that are located at corners of the active device array substrate respectively.

In an embodiment of the invention, the pressure sensing layer includes at least one first pressure sensing pad and a plurality of second sensing pads. The at least one first pressure sensing pad is located on a first side of the active device array substrate and the second sensing pads are located on a second side of the active device array substrate. The first side and the second side are opposite to each other, and a surface area of the first pressure sensing pad is larger than a surface area of one of the second pressure sensing pads.

In an embodiment of the invention, the embedded touch display panel at least includes the active device array substrate, an active device layer, a display medium layer, and an opposite substrate that are stacked sequentially. The pressure sensing layer includes a sensing layer and a planar layer, and the sensing layer is located between the active device array substrate and the active device layer while the planar layer is located between the sensing layer and the active device layer.

In an embodiment of the invention, the pressure sensing layer is disposed under the active device array substrate of the embedded touch display panel and located between the active device array substrate and the backlight module.

In an embodiment of the invention, the handheld electronic device further includes a system circuit board, a power supply, and a covering layer. The system circuit board is disposed in the receiving recess of the case and located between the metal layer and the case. The power supply is disposed in the receiving recess of the case and located between the metal layer and the case. The covering layer is disposed on the case and covers the touch display module.

Based on the above, in the handheld electronic device of the invention, the pressure sensing layer is built in the touch display module. Moreover, the pressure sensing layer, the air gap, and the metal layer constitute the capacitor unit. Therefore, when the user presses on the handheld electronic device of the invention, a touch sensing signal is generated. What is more, when the pressure caused by the pressing increases and causes the touch display module to deform such that the capacitor unit composed of the pressure sensing layer, the air gap, and the metal layer has a capacitance change, the handheld electronic device is capable of sensing the pressure. Simply put, the handheld electronic device of the invention has both touch function and pressure sensing function, which is convenient to use.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1A is a schematic view of a handheld electronic device according to an embodiment of the invention.

FIG. 1B is a schematic view of a common electrode pattern according to an embodiment of an embedded touch display panel of FIG. 1A.

FIG. 1C is a schematic view of a common electrode pattern according to another embodiment of the embedded touch display panel of FIG. 1A.

FIG. 2A is a schematic view of another handheld electronic device according to an embodiment of the invention.

FIG. 2B is a schematic view of an active device array substrate and a pressure sensing layer according to an embodiment of an embedded touch display panel of FIG. 2A.

FIG. 2C is a schematic view of an active device array substrate and a pressure sensing layer according to another embodiment of the embedded touch display panel of FIG. 2A.

FIG. 3 is a schematic view of a handheld electronic device according to another embodiment of the invention.

FIG. 4 is a schematic view of a handheld electronic device according to another embodiment of the invention.

### DESCRIPTION OF THE EMBODIMENTS

Descriptions of the invention are given with reference to the exemplary embodiments illustrated by the figures. Wherever possible, the same reference numerals are used in the figures and the description to refer to the same or similar parts.

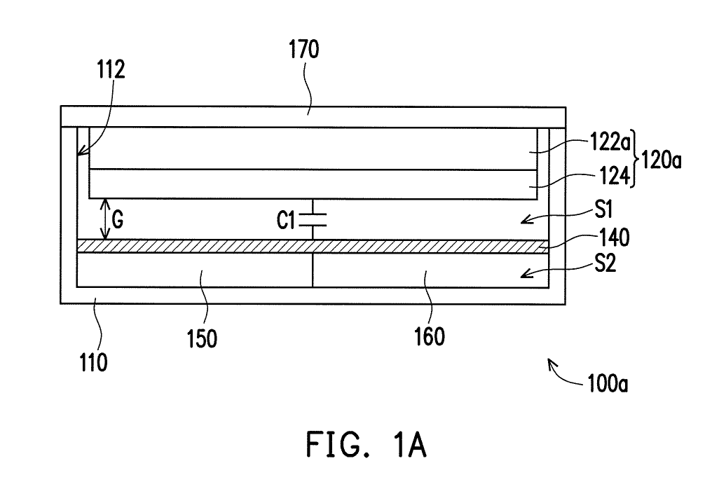

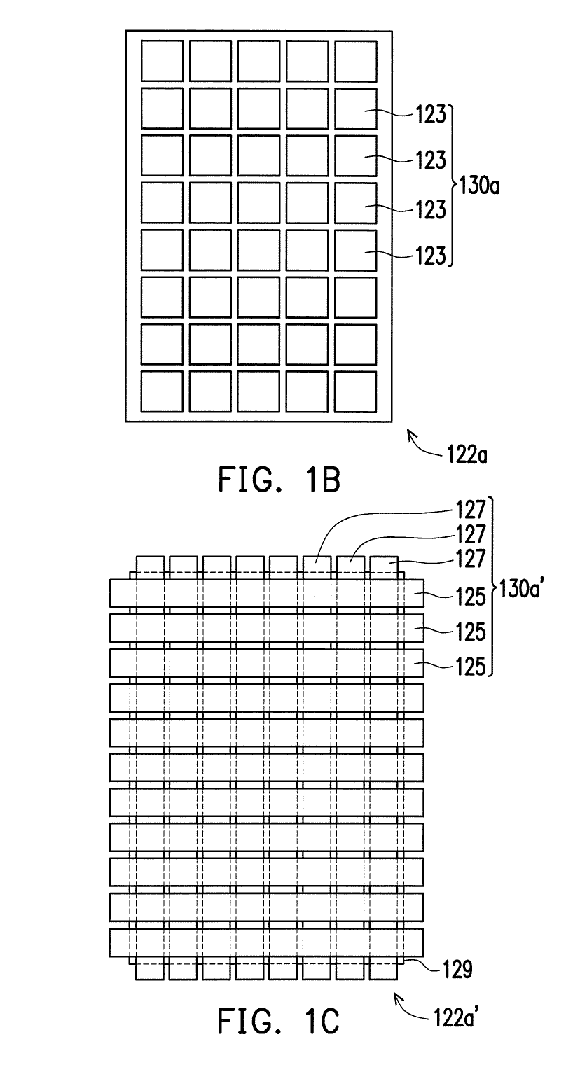

FIG. 1A is a schematic view of a handheld electronic device according to an embodiment of the invention. FIG. 1B is a schematic view of a common electrode pattern according to an embodiment of an embedded touch display panel of FIG. 1A. For purposes of illustration, some components may be omitted from FIG. 1A and FIG. 1B. Referring to FIG. 1A and FIG. 1B, a handheld electronic device 100a of this embodiment includes a case 110, a touch display module 120a, a pressure sensing layer 130a, and a metal layer 140. The case 110 has a receiving recess 112. The touch display module 120a is disposed in the receiving recess 112 of the case 110 and includes an embedded touch display panel 122a and a backlight module 124 located under the embedded touch display panel 122a. The pressure sensing layer 130a is built in the touch display module 120a. The metal layer 140 is disposed in the receiving recess 112 of the case 110 and is located under the backlight module 124. An air gap G exists between the metal layer 140 and the backlight module 124. The pressure sensing layer 130a, the air gap G, and the metal layer 140 constitute a capacitor unit C1.

Specifically, the handheld electronic device 100a of this embodiment is a mobile phone, a multimedia player, a personal digital assistant, a handheld game console, a handheld navigation system, or a laptop computer, for example, which is relatively small and light in weight and easy to be carried around and operated by the user. Referring to FIG. 1A and FIG. 1B, the embedded touch display panel 122a of the touch display module 120a is a self-capacitive touch display panel, for example, which includes a plurality of common electrode patterns 123 that are separated from one another and have touch and pressure sensing functions. The common electrode patterns 123 define the pressure sensing layer 130a. That is to say, the common electrode patterns 123 of this embodiment not only serve as a common electrode of the embedded touch display panel 122a but also serve as a touch electrode and a pressure sensing electrode of the embedded touch display panel 122a.

Specifically, the common electrode patterns 123 achieve the functions of the common electrode, the touch electrode, and the pressure sensing electrode in a time-sharing manner. For example, during display, a pixel electrode in the embedded touch display panel 122a provides a voltage for display to the common electrode patterns 123; when the display continues and comes to a certain period of time, a gate driving circuit in the embedded touch display panel 122a is stopped to provide a touch detection voltage to the common electrode patterns 123 for touch detection; and when the voltage of the embedded touch display panel 122a is 0 (i.e. a V-blanking state), the common electrode patterns 123 may serve as the pressure sensing electrode for sensing pressure. Here, the common electrode pattern 123 is square, for example, but the invention is not limited thereto.

In another embodiment, referring to FIG. 1C, an embedded touch display panel 122a′ is a mutual-capacitive touch display panel, which includes a plurality of common electrode patterns 125 and 127 that are separated from one another and have the touch and pressure sensing functions. The common electrode patterns 125 and 127 define a pressure sensing layer 130a′. Here, the common electrode patterns 125 and 127 are rectangular, for example, wherein the common electrode patterns 125 may be deemed as a Tx touch electrode while the common electrode patterns 127 may be deemed as a Rx touch electrode. The common electrode patterns 125 and 127 are located on an active device array substrate of the embedded touch display panel 122a and an opposite substrate respectively, and the common electrode patterns 125 and the common electrode patterns 127 may be electrically insulated by an insulating layer 129.

It should be noted that the common electrode patterns 123, 125, and 127 are not necessarily all pressure sensing electrodes. The user may select part of the common electrode patterns 123, 125, and 127 as pressure sensing electrodes through proper design to select only the common electrode patterns 123 at four corners of FIG. 1B as the pressure sensing electrodes; or select only the outermost two strips of common electrode patterns 125 and the outermost two strips of common electrode patterns 127 of FIG. 1C as the pressure sensing electrodes. The aforementioned still falls within the scope of the invention.

Moreover, as shown in FIG. 1A, the metal layer 140 of this embodiment may be deemed as a separator for dividing the receiving recess 112 of the case 110 into two receiving spaces S1 and S2, and the touch display module 120a is located in the receiving space S1. In addition to being deemed as a separator, the metal layer 140 may function as an electromagnetic mask depending on material properties for reducing the influence of electromagnetic interference (EMI) on the touch display module 120a.

In addition, referring to FIG. 1A, the handheld electronic device 100a of this embodiment further includes a system circuit board 150, a power supply 160, and a covering layer 170. The system circuit board 150 is disposed in the receiving recess 112 of the case 110 and is located between the metal layer 140 and the case 110, wherein the system circuit board 150 is located in the receiving space S2 and the touch display module 120a is electrically connected with the system circuit board 150 and controls an electric signal through the system circuit board 150. The power supply 160 is disposed in the receiving recess 112 of the case 110 and is located between the metal layer 140 and the case 110, wherein the power supply 160 is located in the receiving space S2 and supplies power for the entire handheld electronic device 100a. The covering layer 170 is disposed on the case 110 and covers the touch display module 120a for protecting the touch display module 120a. As shown in FIG. 1A, the case 110 and the covering layer 170 completely seal the touch display module 120a, the metal layer 140, the system circuit board 150, and the power supply 160.

The pressure sensing layer 130a (or 130a′) of the handheld electronic device 100a of this embodiment is built in the touch display module 120a. Moreover, the pressure sensing layer 130a (130a′), the air gap G, and the metal layer 140 constitute the capacitor unit C1. Therefore, when the user presses on the handheld electronic device 100a of this embodiment, a capacitive touch sensing signal is generated. What is more, when the pressure caused by the pressing increases and causes the touch display module 120a to deform such that the capacitor unit C1 composed of the pressure sensing layer 130a (or 130a′), the air gap G, and the metal layer 140 has a capacitance change, the handheld electronic device 100a is capable of sensing the pressure. Simply put, the handheld electronic device 100a of this embodiment has both touch function and pressure sensing function, which is convenient for the user to use.

It should be noted that the reference numerals and a part of the contents in the previous embodiment are used in the following embodiments, in which identical reference numerals indicate identical or similar components, and repeated description of the same technical contents is omitted. Please refer to the description of the previous embodiment for the omitted contents, which will not be repeated hereinafter.

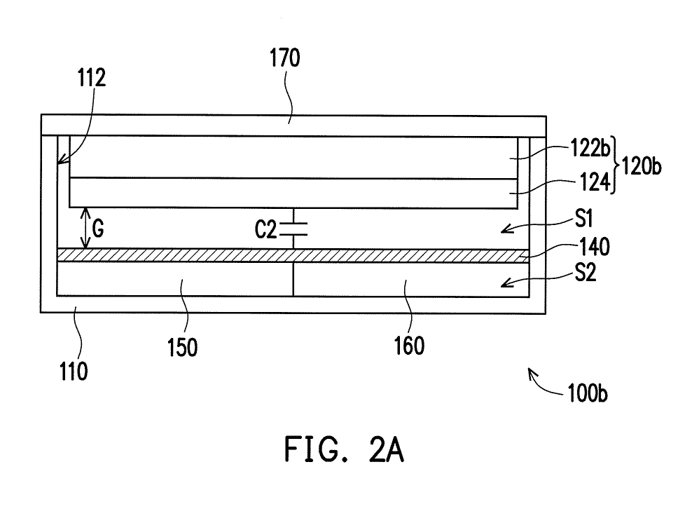

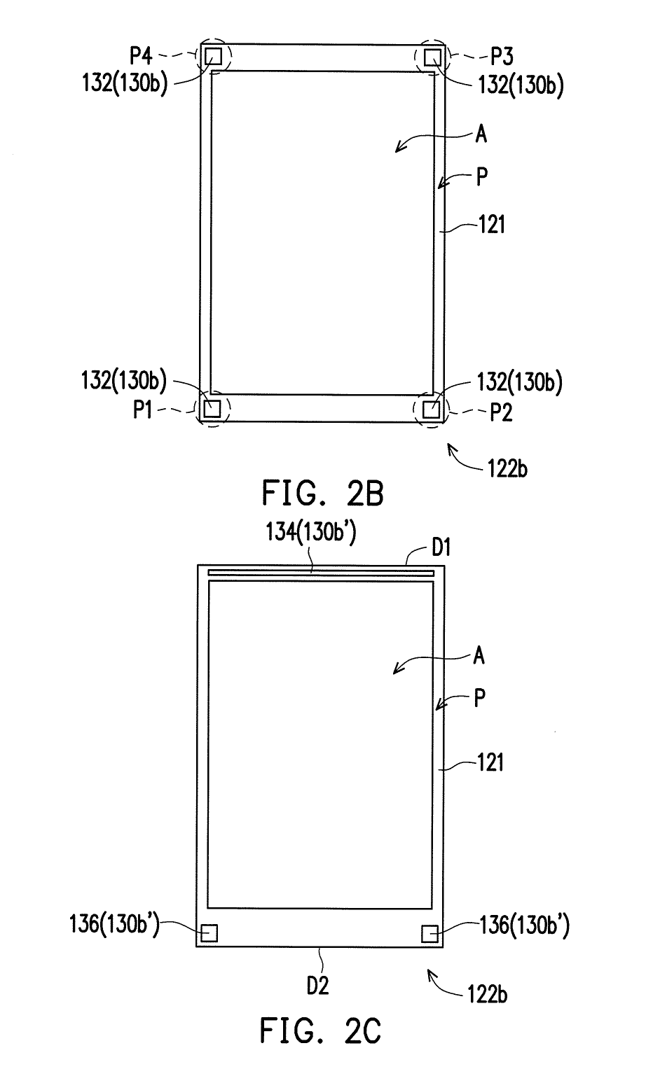

FIG. 2A is a schematic view of another handheld electronic device according to an embodiment of the invention. FIG. 2B is a schematic view of an active device array substrate and a pressure sensing layer according to an embodiment of the embedded touch display panel of FIG. 2A. For purposes of illustration, some components may be omitted from FIG. 2A and FIG. 2B. Referring to FIG. 2A and FIG. 2B, a handheld electronic device 100b of this embodiment is similar to the handheld electronic device 100a of FIG. 1A and a main difference therebetween is that: in this embodiment, a pressure sensing layer 130b is built in a peripheral region P of an active device array substrate 121 of an embedded touch display panel 122b. That is, the pressure sensing layer 130b is located only in the peripheral region P of the active device array substrate 121 and is not in a display region A of the active device array substrate 121. Specifically, the pressure sensing layer 130b of this embodiment may share a photomask with a gate line, a source line, a common electrode layer, or a pixel electrode on the active device array substrate 121 of the embedded touch display panel 122b, so as to reduce the number of the photomasks used and lower the production costs. As shown in FIG. 2B, the pressure sensing layer 130b includes a plurality of pressure sensing pads 132 located at corners P1, P2, P3, and P4 of the active device array substrate 121 respectively, wherein the pressure sensing pads 132 may transmit the pressure sensing signal to the peripheral region of the active device array substrate 121 by routing to output the signal. Here, the pressure sensing pads 132 are square, but the invention is not limited thereto.

In another embodiment, referring to FIG. 2C, a pressure sensing layer 130b′ includes at least one first pressure sensing pad 134 and a plurality of second pressure sensing pads 136, wherein the first pressure sensing pad 134 is located on a first side D1 of the active device array substrate 121 and the second pressure sensing pads 136 are located on a second side D2 of the active device array substrate 121. Here, the first side D1 and the second side D2 are opposite to each other, and a surface area of the first pressure sensing pad 134 is larger than a surface area of each of the second pressure sensing pads 136. As shown in FIG. 2C, the first pressure sensing pad 134 is rectangular and the second pressure sensing pad 136 is square. That is to say, the first pressure sensing pad 134 and the second pressure sensing pads 136 may have different shapes and may be arranged according to the design of the touch display panel 120b and not limited to this disclosure.

Simply put, based on different sensing methods, the embedded touch display panel 122b of this embodiment may be a resistive touch panel, a capacitive touch panel, an optical touch panel, an acoustic-wave touch panel, or an electromagnetic touch panel. Nevertheless, the invention is not limited to the foregoing. The pressure sensing layer 130b is built in the touch display module 120b. Moreover, the pressure sensing layer 130b, the air gap G, and the metal layer 140 constitute a capacitor unit C2. Therefore, when the user presses on the handheld electronic device 100b of this embodiment, a touch sensing signal is generated. What is more, when the pressure caused by the pressing increases and causes the touch display module 120b to deform such that the capacitor unit C2 composed of the pressure sensing layer 130b, the air gap G, and the metal layer 140 has a capacitance change, the handheld electronic device 100b is capable of sensing the pressure. In other words, the handheld electronic device 100b of this embodiment has both touch function and pressure sensing function, which is convenient for the user to use.

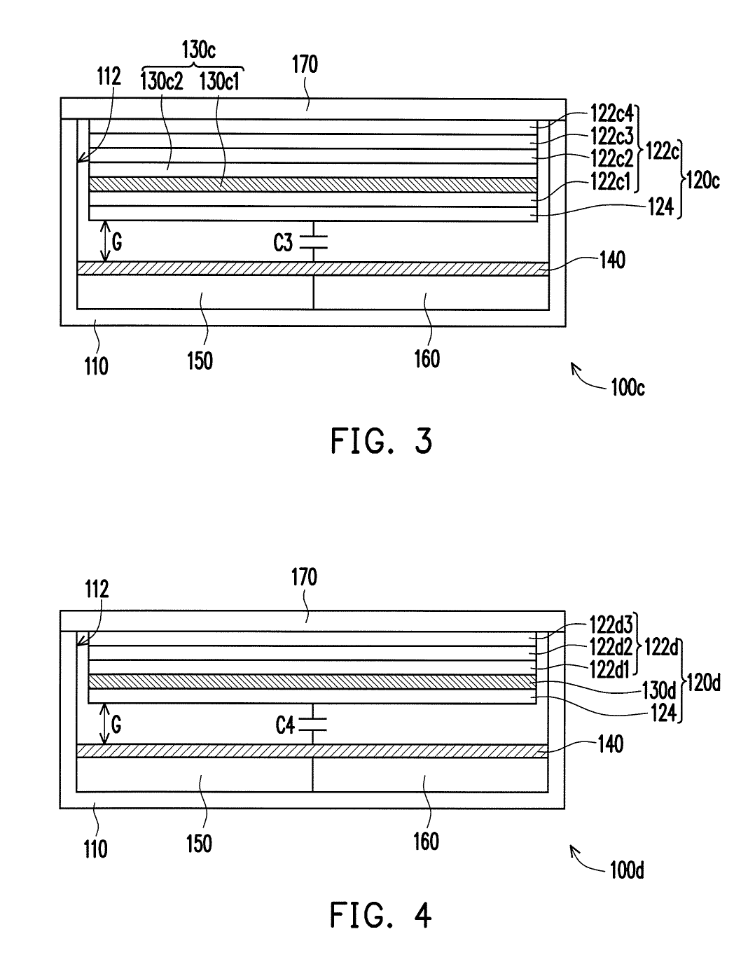

FIG. 3 is a schematic view of a handheld electronic device according to another embodiment of the invention. For purposes of illustration, some components are omitted from FIG. 3. Referring to FIG. 3, a handheld electronic device 100c of this embodiment is similar to the handheld electronic device 100b of FIG. 2A and a main difference therebetween is that: an embedded touch display panel 122c of a touch display module 120c of this embodiment at least includes an active device array substrate 122c1, an active device layer 122c2, a display medium layer 122c3, and an opposite substrate 122c4 that are stacked sequentially. The pressure sensing layer 130c includes a sensing layer 130c1 and a planar layer 130c2, wherein the sensing layer 130c1 is located between the active device array substrate 122c1 and the active device layer 122c2, and the planar layer 130c2 is located between the sensing layer 130c1 and the active device layer 122c2. Here, the display medium layer 122c3 is a liquid crystal layer, for example, which means that the embedded touch display panel 122c is an embedded touch liquid crystal display panel. Nevertheless, the invention is not limited thereto.

Referring to FIG. 3 again, the sensing layer 130c1 of the pressure sensing layer 130c of this embodiment may be designed to be planar or patterned, and a planarization process may be performed with use of the planar layer 130c2 thereon, wherein a material of the planar layer 130c2 is an organic photoresist, for example. The design of the planar layer 130c2 is conducive to the subsequent formation of the active device layer 122c2. In other words, the pressure sensing layer 130c of this embodiment is integrated in the fabrication process of the embedded touch display panel 122c, so as to reduce the production costs and simplify the fabrication process efficiently.

FIG. 4 is a schematic view of a handheld electronic device according to another embodiment of the invention. Referring to FIG. 4, a handheld electronic device 100d of this embodiment is similar to the handheld electronic device 100b of FIG. 2A and a main difference therebetween is that: an embedded touch display panel 122d of a touch display module 120d of this embodiment includes an active device array substrate 122d1, a display medium layer 122d2, and an opposite substrate 122d3 that are stacked sequentially. A pressure sensing layer 130d is disposed under the active device array substrate 122d1 of the embedded touch display panel 122d and located between the active device array substrate 122d1 and the backlight module 124, wherein the pressure sensing layer 130d may be designed to be planar or patterned. Nevertheless, the invention is not limited thereto.

To conclude the above, in the handheld electronic device of the invention, the pressure sensing layer is built in the touch display module. Moreover, the pressure sensing layer, the air gap, and the metal layer constitute the capacitor unit. Therefore, when the user presses on the handheld electronic device of the invention, a touch sensing signal is generated. What is more, when the pressure caused by the pressing increases and causes the touch display module to deform such that the capacitor unit composed of the pressure sensing layer, the air gap, and the metal layer has a capacitance change, the handheld electronic device is capable of sensing the pressure. Simply put, the handheld electronic device of the invention has both touch function and pressure sensing function, which is convenient to use.

It will be apparent to those skilled in the art that various modifications and variations can be made to the disclosed embodiments without departing from the scope or spirit of the invention. In view of the foregoing, it is intended that the invention covers modifications and variations provided that they fall within the scope of the following claims and their equivalents.

What is claimed is:

1. A handheld electronic device, comprising:
a case having a receiving recess;
a touch display module disposed in the receiving recess of the case and comprising an embedded touch display panel and a backlight module located under the embedded touch display panel;
a pressure sensing layer built in the touch display module; and
a metal layer disposed in the receiving recess of the case and located under the backlight module, wherein an air gap exists between the metal layer and the backlight module, and the pressure sensing layer, the air gap, and the metal layer constitute a capacitor unit.

2. The handheld electronic device as recited in claim 1, wherein the embedded touch display panel comprises a plurality of common electrode patterns that are separated from one another and have touch and pressure sensing functions, wherein the common electrode patterns define the pressure sensing layer.

3. The handheld electronic device as recited in claim 2, wherein a shape of the common electrode patterns is square or rectangular.

4. The handheld electronic device as recited in claim 2, wherein the embedded touch display panel is a self-capacitive touch display panel or a mutual-capacitive touch display panel.

5. The handheld electronic device as recited in claim 1, wherein the pressure sensing layer is built in a peripheral region of an active device array substrate of the embedded touch display panel.

6. The handheld electronic device as recited in claim 5, wherein the pressure sensing layer comprises a plurality of pressure sensing pads that are located at corners of the active device array substrate respectively.

7. The handheld electronic device as recited in claim 5, wherein the pressure sensing layer comprises at least one first pressure sensing pad located on a first side of the active device array substrate and a plurality of second sensing pads located on a second side of the active device array substrate, and the first side and the second side are opposite to each other, wherein a surface area of the first pressure sensing pad is larger than a surface area of one of the second pressure sensing pads.

8. The handheld electronic device as recited in claim 1, wherein the embedded touch display panel at least comprises the active device array substrate, an active device layer, a display medium layer, and an opposite substrate that are stacked sequentially, wherein the pressure sensing layer comprises a sensing layer and a planar layer, and the sensing layer is located between the active device array substrate and the active device layer while the planar layer is located between the sensing layer and the active device layer.

9. The handheld electronic device as recited in claim 1, wherein the pressure sensing layer is disposed under the active device array substrate of the embedded touch display panel and located between the active device array substrate and the backlight module.

10. The handheld electronic device as recited in claim 1, further comprising:
a system circuit board disposed in the receiving recess of the case and located between the metal layer and the case;
a power supply disposed in the receiving recess of the case and located between the metal layer and the case; and
a covering layer disposed on the case and covering the touch display module.
